(19) United States
(12) Patent Application Publication
(10) Pub. No.: US 2009/0157750 A1
(43) Pub. Date: Jun. 18, 2009

(54) Integrated multimedia file format structure, and multimedia service system and method based on the intergrated multimedia format structure

(76) Inventors: Munchurl Kim, Daejeon (KR); Jeongyeon Lim, Daejeon (KR)

Correspondence Address: BACON & THOMAS, PLLC, 625 SLATERS LANE, FOURTH FLOOR, ALEXANDRIA, VA, 22314-1176, US

(21) Appl. No.: 11/991,142

(22) PCT Filed: Aug. 31, 2006
(86) PCT No.: PCT/KR2006/003464

§ 371 Date: Feb. 28, 2008

(30) Foreign Application Priority Data
Aug. 31, 2005 (KR) 10-2005-0080818

(51) Int. Cl. G06F 7/00; G06F 17/30; H04L 9/00

(52) U.S. Cl. 707/104.1; 707/100; 713/168; 707/E17.01; 707/E17.032; 707/E17.102; 707/E17.031

(57) ABSTRACT

The present invention provides an integrated multimedia file format structure, and a multimedia service system based on the integrated multimedia format structure. The multimedia service system in accordance with the present invention, unlike the conventional multimedia service system for providing only audio data and simple text information related thereto, produces integrated contents containing compressed audio data, image data, text data, contents protection metadata and license metadata, which enables providing of a multimedia service by using the integrated contents having an integrated multimedia file format structure.

### TECHNICAL FIELD

The present invention relates to an integrated multimedia file format structure, and a multimedia service system and method based on the integrated multimedia file format structure; and, more particularly, to an integrated multimedia file format structure and an integrated multimedia service system and method suitable for generating and providing integrated contents based on the integrated multimedia format structure.

### BACKGROUND ART

As well known, in recent, user terminals have become capable of performing not only a function of communicating but also a function of multimedia data processing such as a picture taking a video recording a music reproduction and the like. In particular, it has been an ordinary task to listen to music files, e.g., MP3 files, by playing them on the user terminals.

Such music files are stored in small portable player devices having their own storage media (e.g., an MP3 player or the like), personal computers (PC) and the like, and a desired one among the music files is extracted therefrom for reproduction.

As for widely used music file formats, there are provided file formats such as MP3 (MPEG-1 Audio Layer IEI), MPEG-2/4 AAC (Advanced Audio Coding), WMA, AVI and the like. These music file formats include simply music data and metadata related to music contents (e.g., a song title, a singer, a music album title, a composer, a composition year, a copyright holder and the like). Accordingly, it is disadvantageous in that a user should listen the music without obtaining further detailed information about the music data.

Furthermore, such music file formats are used for compressing music files and thus utilized in applications such as listening comprehension aids for learning foreign languages, storytelling and the like. However, in those application environments, they are provided in file formats which are not capable of supplementing image files or contents-related text information with related contents in synchronization with music sources. That is, the music file formats have been limitedly used in applications that are dependent only on the music sources.

For example, the MP3 includes not only compressed audio data but also metadata related to limited music contents (e.g., a song title, a singer, an album title, a musical composer, a composition year, a copyright holder and the like). Since the metadata provides related information, it is possible to complement somewhat the problem of listening to the music files without obtaining detailed information thereof.

Furthermore, the players for reproducing music files have a limited battery lifespan, computing capability and storage capacity when they are portable players. Furthermore, they generally include a limiting display device (i.e., capable of providing only text information).

In order to overcome such problems for MP3 music files, an MP3 player is configured to connect with a server via a network and transmits related information such as a song title and the like while reproducing the Mp3 music files. In response thereto, the server provides lyrics of the related music files to the MP3 player and then reproduces music data while displaying the lyrics in synchronization therewith.

However, such a conventional method has a drawback in that it is not possible to receive and display the lyrics when the MP3 player is not in connection with the network. Moreover, in order to constantly receive the lyrics for displaying high costs are required for the network connection.

### DISCLOSURE OF INVENTION

### Technical Problem

It is, therefore, a primary object of the present invention to provide an integrated multimedia file format structure capable of integrating (or combining) contents including at least one set of image data text data, video data relating to audio data, contents protection metadata and license information metadata.

It is another object of the present invention to provide a multimedia service system and method capable of generating and providing integrated contents based on the integrated multimedia file format structure.

### Technical Solution

In accordance with one aspect of the invention, there is provided an integrated multimedia file format structure for integrating contents containing at least one among compressed video data, image data, text data and contents information metadata, which correspond to compressed audio data, by using an ISO based file format, the integrated multimedia file format structure including: a moov box for indicating at least one data among the compressed video data, the image data, the text data, script data for applying animation effects to image, video and text data, the contents protection metadata and license protection metadata, which correspond to compressed audio data, using a multiplicity of trak boxes, and for specifying synchronized text data in an additional trak box; a mdat box containing the data indicated by the trak boxes of the moov box and the synchronized text data corresponding to the additional trak box; and a meta box for storing metadata where information on the contents is recorded.

In accordance with another aspect of the invention, there is provided a multimedia service system for providing integrated contents having an integrated multimedia file format structure, the system including: a content server system for assigning a rights to use the integrated contents, generating license information metadata according to the rights to use the contents, encrypting the contents according to the license information metadata and generating contents protection metadata related to the encryption, thereby generating the integrated contents having the integrated multimedia file format structure and transmitting the same via a network; and a user terminal for storing the integrated contents received via the network, decrypting and decoding the stored integrated contents according to the license information metadata and the contents protection metadata, displaying the decoded contents and executing the displayed contents according to an instruction for executing the integrated contents.

In accordance with still another aspect of the invention, there is provided a multimedia service method for providing integrated contents having an integrated multimedia file format structure, the method including the steps of: determining whether or not an integrated content request receiving unit of a content server system has received a content request signal transmitted via a network; performing a user authentication and checking the license of a user's rights to use contents if the integrated content request signal is received; requesting proper contents according to the user authentication and the license and then encrypting the contents as requested according to a content protection method; generating content protection metadata for recording information describing the content protection method and license metadata for recording license information of the contents; generating one integrated contents by using the encrypted contents, the contents protection metadata and the license metadata according to synchronization information and then transmitting the integrated contents to a user terminal via a network; and storing the integrated contents received from the user terminal.

In accordance with still another aspect of the invention, there is provided a multimedia service method for providing integrated contents having an integrated multimedia file format structure, the method including the steps of: determining whether or not integrated contents are requested from user terminals; determining whether or not the requested contents exist if the integrated contents are requested; displaying decrypted metadata of the integrated contents after checking a rights to contents and then displaying context and sources of the requested integrated contents if the requested contents exist, entire lists of pre-stored integrated contents; extracting and decrypting the corresponding contents if an instruction is inputted from the user terminals, according to the user's rights stored in the user terminals or a storage medium; and decoding and rendering the decrypted integrated contents according to the synchronization information and then executing the decoded integrated contents.

### ADVANTAGEOUS EFFECTS

As described above, unlike the conventional multimedia service system which provides only audio data and simple text information related thereto only, the multimedia service system in accordance with the present invention produces integrated contents containing compressed audio data, image data, text data, script data for applying animation effects to the image, the text and the video data, contents protection metadata and license metadata. By providing such integrated contents, the compressed audio data is synchronized with the image and the text data related thereto. Consequently, the multimedia service system can effectively generate and provide integrated contents having an integrated multimedia file format structure.

And also, by providing the integrated contents having the integrated multimedia file format structure, the compressed audio data can be simultaneously executed in synchronization with the image data, the text data and the like related thereto. As a result, needs demands of the user using multimedia services can be satisfied.

### BRIEF DESCRIPTION OF THE DRAWINGS

The above and other objects and features of the present invention will become apparent from the following description of preferred embodiments, given in conjunction with the accompanying drawings, in which:

FIGS. 1 to 6 show various examples of an integrated multimedia file format structure in accordance with a first preferred embodiment of the present invention;

FIG. 7 describes another example of the integrated multimedia file format structure in accordance with the first preferred embodiment of the present invention;

FIG. 8 provides an example of an integrated multimedia file format structure in accordance with a second preferred embodiment of the present invention;

FIG. 9 presents another example of the integrated multimedia file format structure in accordance with the second preferred embodiment of the present invention;

FIG. 10 represents an IPMP general descriptor schema for describing general information on contents protection tools in accordance with the present invention;

FIG. 11 depicts an IPMP information descriptor schema for describing information on contents protection tools for protecting specific contents in accordance with the present invention;

FIG. 12 illustrates an example of a file format structure for protecting single track audio and image data by using an MPEG-4 file format in accordance with the present invention;

FIG. 13 describes another example of the file format structure for protecting single track audio and image data by using the MPEG-4 file format in accordance with the present invention;

FIG. 14 shows a file format structure for protecting multiple trak audio and image data by using the MPEG-4 file format in accordance with the present invention;

FIG. 15 provides a block diagram of a contents service system suitable for providing multimedia contents generated based on an integrated multimedia file format structure in accordance with the present invention;

FIG. 16 is a flow-chart illustrating a process for providing in response to a request for the integrated contents having the integrated multimedia file format structure, contents previously stored in the contents service system in accordance with the present invention; and

FIG. 17 offers a flow-chart showing a process for providing the integrated contents having the integrated multimedia file format structure in response to an integrated contents request signal in the contents service system in accordance with the present invention.

### BEST MODE FOR CARRYING OUT THE INVENTION

Hereinafter, preferred embodiments of the present invention will be described in detail with reference to the accompanying drawings.

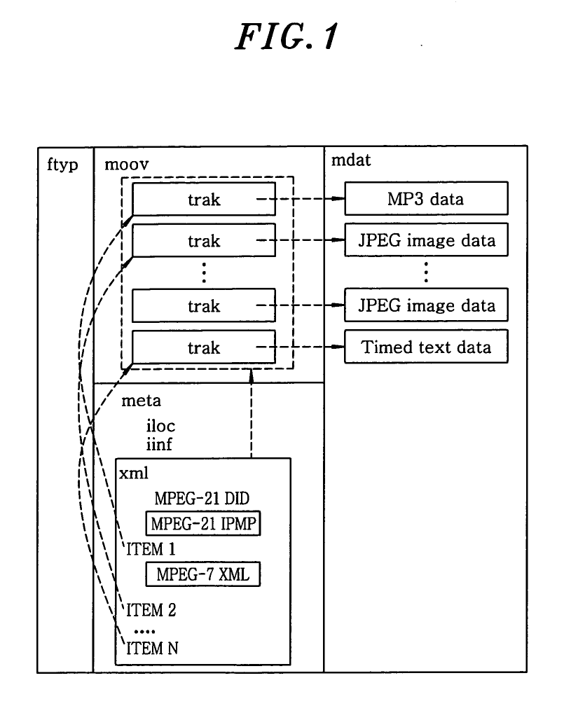

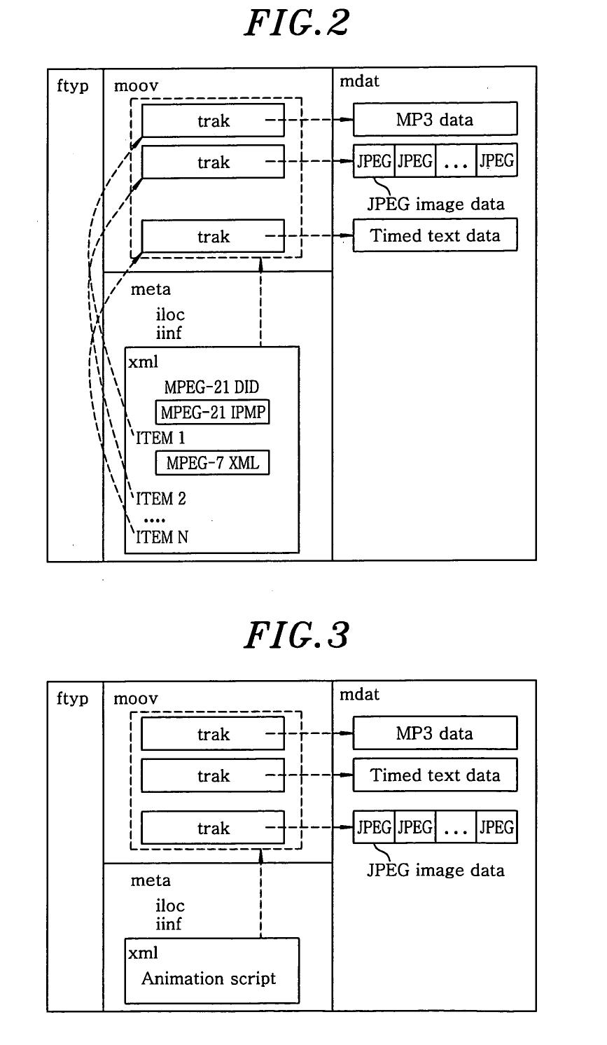

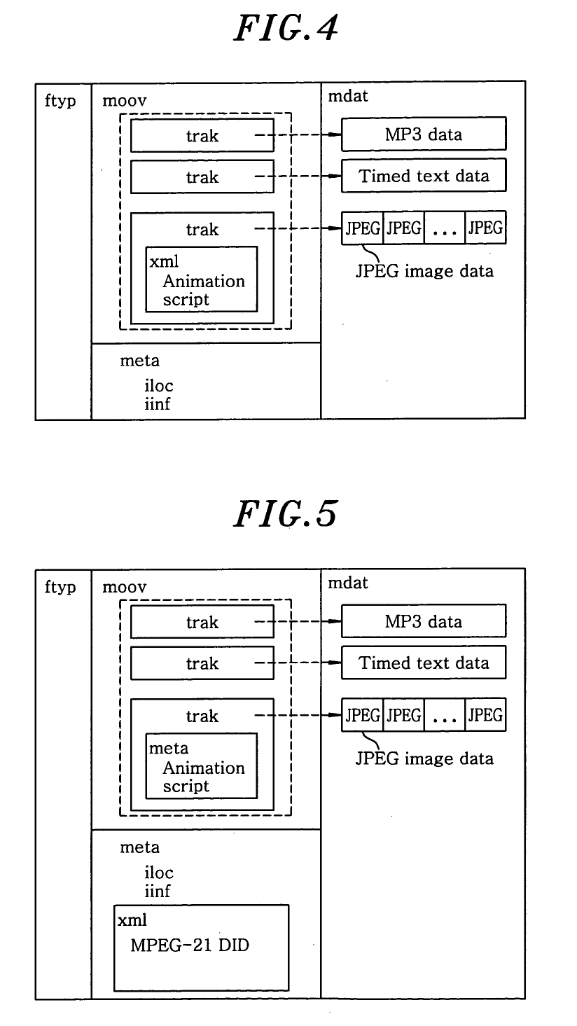

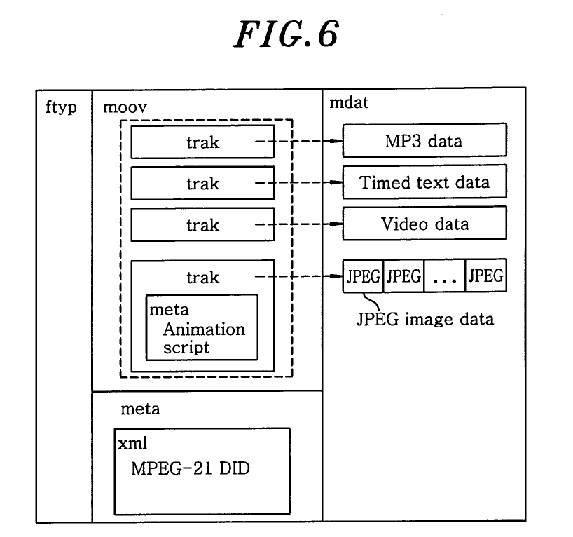

Referring to FIGS. 1 to 6 show various examples of an integrated multimedia file format structure in accordance with a first preferred embodiment of the present invention.

As sown in FIG. 1, an MPEG-4 file format structure is used for integrating compressed audio data and at least one related data among images (e.g., pictures of a singer, picture of a music album, story-related pictures (cartoon), pictures showing tongue positions for pronunciation of words, images for illustrating situations related to dialogues for language study and the like) data; audio related text data (lyrics, story sentences, dialogue sentences for language learning text related to the pronunciation of words and the like); script data for applying animation effects to image, video and text data; synchronized data of the aforementioned data; content protection information metadata related to a data protection (encryption); and license information metadata on the user's rights to use related contents. Herein, “ftype” represents a file type; “moov” contains trak boxes for respectively specifying metadata; “mdat” contains data related to each of the trak boxes; and “meta” contains the metadata specified by each of the trak boxes. The meta box may contain at least one of the content protection metadata, the license information metadata and asynchronous MPEG-7 metadata. Furthermore, at least one of them may be recorded by using an MPEG-21 DID. The contents protection metadata and the license information metadata may represent content protection information by using an MPEG-21 IPMP (Intellectual Property Management and Protection) standard.

The script data for applying animation effects to the images, video and text data may be configured by using at least one among an MPEG-4 LASeR (Lightweight Application Scene Representation) standard, an SMIL (Synchronized Multimedia Integration Language) standard, an SVG (Scalable Vector Graphic) standard, an SVG Tiny standard and an XML standard.

The compressed audio data (e.g., MP3 audio data and the like) indicates MP3 data in the mdat box with its dedicated trak box in the moov box of the MPEG-4 file format and also indicates audio related text data (e.g., MPEG-7 metadata and the like) in the mdat box with another trak box. Moreover, at least one image data (e.g., JPEG image and the like) related to the compressed audio data indicates other trak boxes in the moov box.

When the MPEG-7 metadata contains text contents such as lyrics, story sentences, dialogues for learning (foreign) languages and the like, time information data (i.e., time stamp) is contained in a first sentence or a first syllable for synchronization when reproducing the music data (MP3). Furthermore, the synchronization text data such as lyrics, story sentences, dialogue sentences for language learning text related to the pronunciation of words and the like is formed as a separate timed text to be specified by one file, or one trak box in the moov box. Moreover, synchronization information, e.g., a time stamp, an offset, a chunk unit and the like, is contained in the synchronization text data which can be defined in the trak boxes of the MPEG-4 file format, so that the synchronization text data can be synchronized with audio data when reproducing the audio data.

On one hand, the trak boxes indicating image data (e.g., JPEG data) contain time information (e.g., a time stamp, an offset, a chunk unit and the like) for synchronizing each image with music when reproducing the music. Also, these trak boxes may contain the script data for applying animation effects to the image data in order to convert them into other images. If the data indicated by the trak boxes are protected (encrypted), the content protection metadata related to matters concerning which encryption method(s) is(are) used, which block(s) is(are) encrypted, the information about where key data is obtained for decryption, etc. and the license information metadata related to rights to use contents are recorded in an xml box in the meta box by using an MPEG-21 IPMP (Intellectual Property Management and Protection) components. At this time, the metadata may be encrypted with a hash function and include digital signature data to check the integrity of the MPEG-21 IPMP metadata.

In such an integrated multimedia file format structure, it is understood that it is possible to employ audio file formats other than MP3 for a music data file, and other additional file formats such as addition MPEG-2/4 AAC, WMA, AVI, G.723, PCM, MPEG-4 ALS (Audio Lossless Coding), MPEG-4 DST (Lossless Coding of oversampled audio) and the like. Furthermore, as for an image data file, there can be employed image file formats other than JPEG, such as PNG, BMP, TIFF, JPEG2000, MPEG I-frame, GIF, animated GIF, PGMYUV, PGM, YUV, SGI and the like. Furthermore, as for a video data file, it is possible to support at least one among H.264/AVC, SVC, MPEG-1, MPEG-2, MPEG-4, WMV, H.261, H.263, H.26L, AVI, RealVideo, DV, MJPEG, Apple Video file format and the like.

The asynchronous MPEG-7 metadata (e.g., a song title, a music album title, a singer and the like) may be contained in the MPEG-21 DID of the xml box for the meta box. Moreover, the text data that requires synchronization (e.g., text for song lyrics, story sentences, and dialogues for language learning text related to the pronunciation of words and the like) with audio or images may be contained in the mdat box, which is corresponding to an additional trak box. Each item information indicating each trak box of the MPEG-21 DID in the meta box may be mapped with info and iloc information in the meta box, respectively.

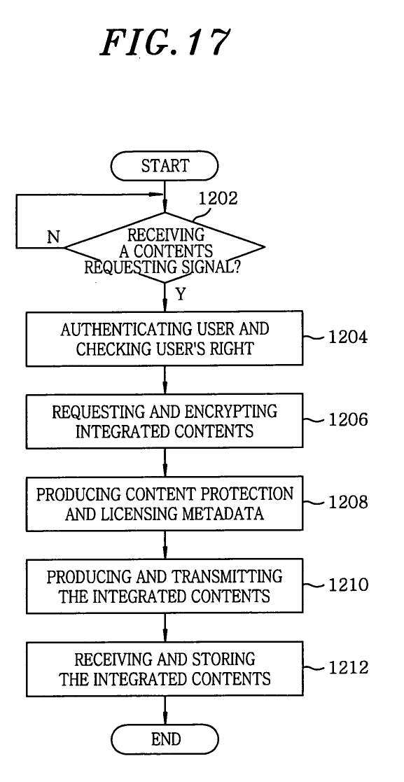

As particularly shown in FIG. 16, it is also possible to configure integrated multimedia contents including a trak box for video data.

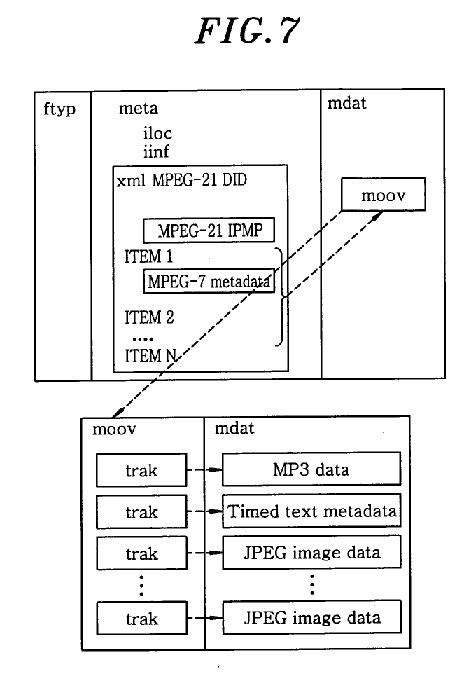

FIG. 7 describes another example of the integrated multimedia file format structure in accordance with the first preferred embodiment of the present invention. Referring to FIG. 7, the moov box in the mdat box can be formed of various integrated multimedia file formats shown in FIGS. 1 to 6.

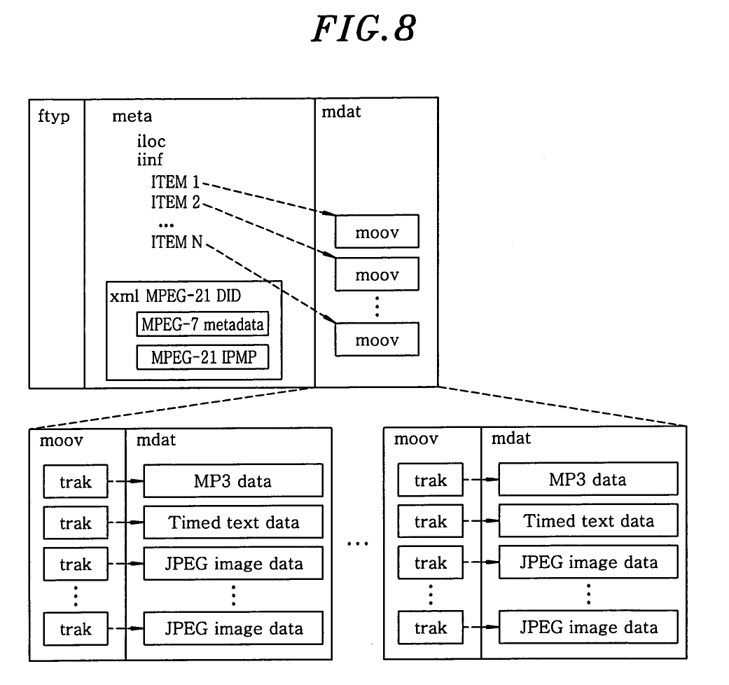

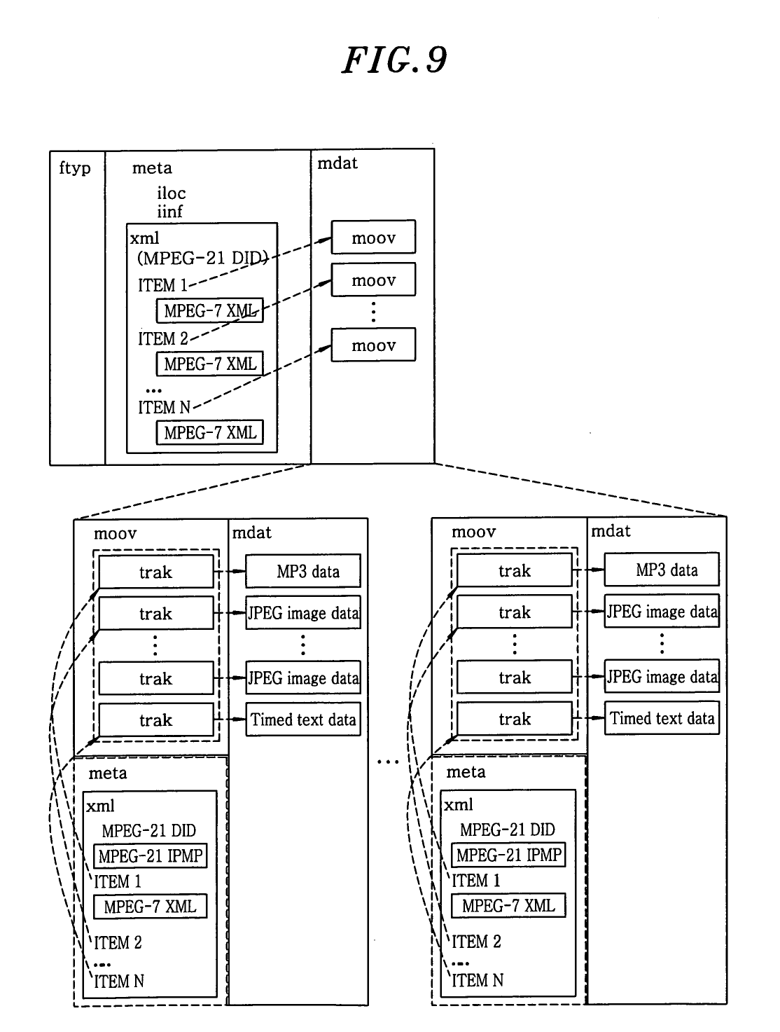

FIG. 8 provides an example of an integrated multimedia file format structure in accordance with a second preferred embodiment of the present invention. The moov box in the mdat box of FIG. 8 can be formed of various integrated multimedia file formats shown in FIG. 7.

Referring to FIG. 8, one or more audio trak boxes such as a music CD title and the like can be implemented as an integrated file format structure for music album data. At least one or more audio trak boxes may exist as an MPEG-4 file format in the mdat box. In that case, the audio trak box may be implemented with one additional file structure shown FIGS. 1 to 6, as similar as an integrated file format structure indicated by the moov box.

In this regard, each item information indicating each trak box of the MPEG-21 DID in the meta box may be mapped with info and iloc information in the meta box, respectively.

As for another example of the integrated multimedia file format structure in accordance with the second preferred embodiment of FIG. 8, there can be provided an integrated multimedia file format structure shown in FIG. 9.

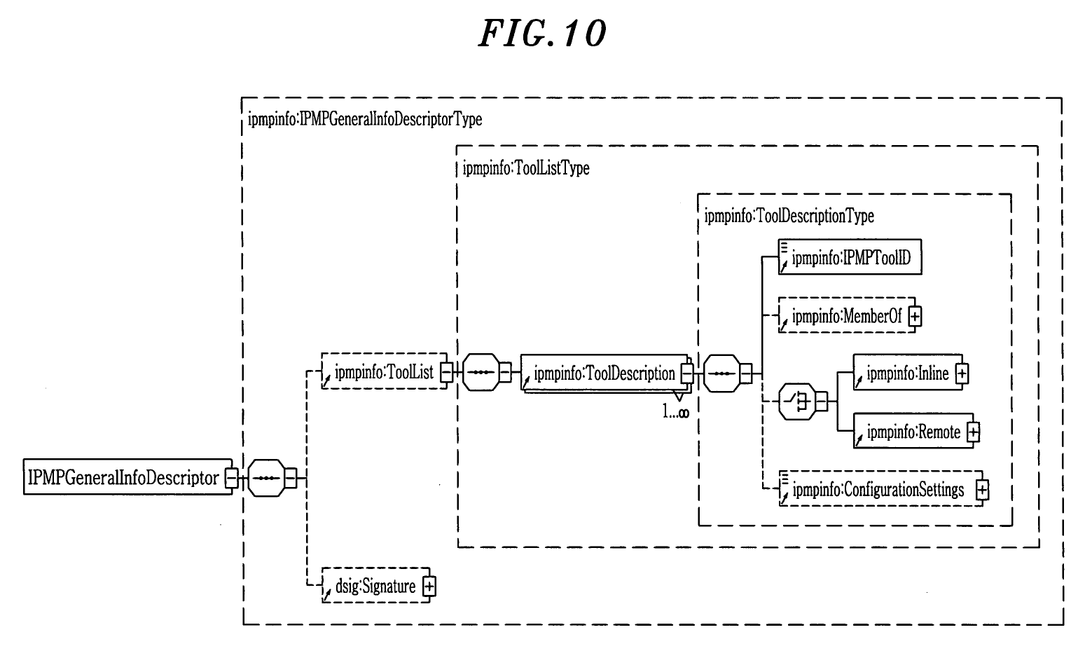

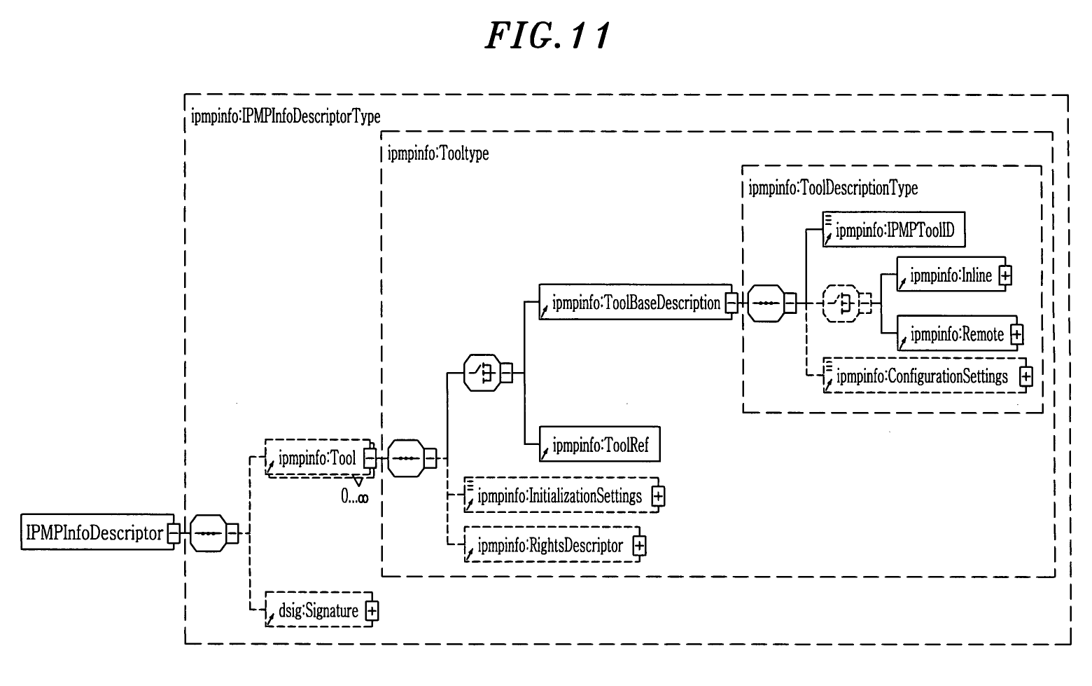

FIG. 10 represents an IPMP general descriptor schema for describing general information on content protection tools in accordance with the present invention.

Referring to FIG. 10, the audio data, the image data and the text data can be simplified based on the MPEG-21 IPMP component standard specification (ISO/IEC 21004) for protection of contents thereof. The IPMP general information descriptor of the MPEG-21 IPMP can describe contents protection tool information, e.g., a contents encryption tool (algorithm) identification number, tool member information, a data container capable of directly recording tool data, actual position information of a tool when the tool exists external, a container containing digital signature information for demonstrating integrity of the content protection metadata, and the like. Specific data types are illustrated in Tables 1 and 2.

Table 1 explains the semantics of the IPMP general information descriptor schema of the MPEG-21 IPMP which describes general information on the content protection tools in accordance with the present invention. Table 2 explains specific semantic of elements indicating tool description information in the general information descriptor schema of the MPEG-21 IPMP which describes general information on the contents protection tools in accordance with the present invention.

TABLE 1

| | Korean | | |
|---|---|---|---|
| Title | Title | Function | Syntax |
| ToolList | [symbol] | Data type for | <element |

| | |
|---|---|
| recording list of | name=“IPMPGeneralInfoDescriptor” |
| encryption tools | type=“ipmpinfo:IPMPGeneralInfoDescriptor |
| applied to | Type”/> |

| | |
|---|---|
| contents | <complexType |

name=“IPMBGeneralInfoDescriptorType”>

<sequence>

| | |
|---|---|
| <element | ref=“ipmpinfo:ToolList” |

minOccurs=“0”/>

| | |
|---|---|
| <element | ref=“dsig:Signature” |

minOccurs=“0”/>

</sequence>

</complexType>

| | | | </element> |
|---|---|---|---|
| Signature | [symbol] | Data type used for | <element name=“Signature” type=“any”/> |

recording data to
demonstrate integrity of
the contents protection
metadata

TABLE 2

| Title | Function | Syntax | |
|---|---|---|---|
| ToolDescription | Data type used for | <element | name=“ToolDescription” |

| | |
|---|---|
| describing | type=“ipmpinfo:ToolDescriptionType”/> |
| specific | <complexType name=“ToolDescriptionType”> |

| | |
|---|---|
| information on | <sequence> |

| encryption tool | <element ref=“ipmpinfo:IPMPToolID”/> | |
|---|---|---|
| applied to | <element | ref=“ipmpinfo:MemberOf” |

| | |
|---|---|
| contents | minOccurs=“0”/> |

<choice minOccurs=“0”>

<element ref=“ipmpinfo:Inline”/>
<element ref=“ipmpinfo:Remote”/>

</choice>
<element

ref=“ipmpinfo:ConfigurationSettings”
minOccurs=“0”/>

<element

ref=“ipmpinfo:RightsDescriptor”
minOccurs=“0”/>

| | |
|---|---|
| <element | ref=“dsig:Signature” |

minOccurs=“0”/>

| </sequence> | | |
|---|---|---|
| <attribute | name=“localID” | type=“ID” |

| | | use=“required”/> | |
|---|---|---|---|
| | | </complexType> | |
| IPMPToolID | Discriptor for | <element | name=“IPMPToolID” |
| | Exclusively | type=“anyURI”/> | |
| | identifying IPMP | | |
| | tool | | |
| MemberOf | Data type for | <element | name=“MemberOf” |

| | |
|---|---|
| Expressing tool | type=“ipmpinfo:MemberOfType”/> |
| member information | <complexType name=“MemberOfType”> |

<sequence maxOccurs=“unbounded”>

<element

ref=“ipmpinfo:AlternateGroup”/>

</sequence>

| | | </complexType> |
|---|---|---|
| Inline | Data type for | <complexType name=“InlineType”> |

| | |
|---|---|
| directly recording | <sequence> |

| contents | <element ref=“ipmpinfo:Binary”/> | |
|---|---|---|
| protection tool as | <element | ref=“dsig:Signature” |

| | |
|---|---|
| a part of metadata | minOccurs=“0”/> |

</sequence>

| | | </complexType> |
|---|---|---|
| Remote | Data type for | <complexType name=“RemoteType”> |

| | |
|---|---|
| recording position | <sequence> |

| | |
|---|---|
| of contents | <element ref=“dsig:Signature”/> |

| | |
|---|---|
| protection tool | </sequence> |

<attribute name=“ref” type=“anyURI”/>

| | | </complexType> |
|---|---|---|
| ConfigurationSettings | Data type for | <complexType |
| | recording | name=“ConfigurationSettingsType” |
| | environment | mixed=“true”> |

| | |
|---|---|
| parameter value of | <sequence> |

| | | |
|---|---|---|
| contents | <any | namespace=“##any” |

| | |
|---|---|
| protection tool | processContents=“lax” minOccurs=“0”/> |

</sequence>

</complexType>

FIG. 11 depicts an IPMP information descriptor schema for describing information on contents protection tools which protect specific contents in accordance with the present invention.

As shown in FIG. 11, the IPMP information descriptor describes a contents encryption tool (algorithm) identification number, tool member information, a data container capable of directly recording tool data, actual position information of a tool when the tool exists externally, digital signature information for demonstrating integrity of the contents protection metadata, a parameter value used for an actual encryption process, an initialization setting data value, digital signature data for demonstrating integrity of metadata on copyright and license and metadata formed of the aforementioned components, and the like. Specific data types are illustrated in Tables 3 and 4.

Table 3 explains semantics of the IPMP information descriptor schema describing information on the contents protection tools for protecting specific contents in accordance with the present invention. And table 4 explains specific semantics of tool base description information components, initialization setting components and copyright description components in the IPMP information descriptor schema describing tool description information for protecting specific contents in accordance with the present invention.

TABLE 3

| Title | Function | Syntax |
|---|---|---|
| IPMPInfoDescriptorType | Data type for recording | <complexType |
| | information on PIMP tool | name=“IPMPInfoDescriptorType”> |

| | |
|---|---|
| applied to contents | <sequence> |

| | | |
|---|---|---|
| protection | <element | ref=“ipmpinfo:Tool” |

minOccurs=“0”
maxOccurs=“unbounded”/>

<element

ref=“ipmpinfo:RightsDescriptor”
minOccurs=“0”
maxOccurs=“unbounded”/>

| | |
|---|---|
| <element | ref=“dsig:Signature” |

minOccurs=“0”/>

</sequence>

| | | </complexType> |
|---|---|---|
| Tool | Data type for recording | |
| | encryption tool information | |
| | directly applied to | |
| | contents protection | |
| RightsDescriptor | Descriptor for describing | <element |
| | information on copyright | name=“RightsDescriptor” |
| | and license for contents to | type=“ipmpinfo:RightsDescriptor |
| | be protected | Type”/> |

<complexType
name=“RightsDescriptorType”>

<sequence>

<element

ref=“ipmpinfo:IPMPInfoDescripto
r” minOccurs=“0”/>

<choice minOccurs=“0”>

<element

ref=“ipmpinfo:License”/>

<element

ref=“ipmpinfo:LicenseReference”
/>

| | |
|---|---|
| <element | ref=“ipmpinfo: |

LicenseService”/>

</choice>

</sequence>

| | | </complexType> |
|---|---|---|
| InitializationData | Descriptor for describing | <element |
| | initial data setting | name=“InitializationData” |
| | information for decrypting | type=“ipmpinfo:InitializationDa |
| | contents encrypted by | taType”/> |
| | encryption tool | <complexType |

name=“InitializationDataType”
mixed=“true”>

<sequence>

| | |
|---|---|
| <any | namespace=“##any” |

processContents=“lax”
minOccurs=“0”/>

</sequence>

| | | </complexType> | |
|---|---|---|---|
| Signature | Data type for recording | <element | name=“Signature” |

| | |
|---|---|
| data for demonstrating | type=“any”/> |
| integrity of content | |
| protection information | |
| metadata | |

TABLE 4

| Title | Function | Syntax |
|---|---|---|
| ToolBaseDescription | Data type for recording | <complexType |
| | tool base information for | name=“ToolBaseDescriptionType”> |

| | |
|---|---|
| contents protection | <sequence> |

<element

ref=“ipmpinfo:IPMPToolID”/>

<choice minOccurs=“0”>

<element

ref=“ipmpinfo:Inline”/>

<element

ref=“ipmpinfo:Remote”/>

</choice>
<element

ref=“ipmpinfo:ConfigurationSettin
gs” minOccurs=“0”/>

<element ref=“dsig:Signature”

minOccurs=“0”/>

</sequence>

| | | </complexType> | |
|---|---|---|---|
| IPMPToolID | Identifying PMP tool | <element | name=“IPMPToolID” |
| | | type=“anyURI”/> | |
| MemberOf | Data type for expressing | <element | name=“MemberOf” |

| | |
|---|---|
| tool member information | type=“ipmpinfo:MemberOfType”/> |

<complexType name=“MemberOfType”>

<sequence maxOccurs=“unbounded”>

<element

ref=“ipmpinfo:AlternateGroup”/>

</sequence>

| | | </complexType> |
|---|---|---|
| Inline | Data type for directly | <complexType name=“InlineType”> |

| | |
|---|---|
| recording contents | <sequence> |

| | |
|---|---|
| protection tool as a part | <element |

| | |
|---|---|
| of metadata | ref=“ipmpinfo:Binary”/> |

<element ref=“dsig:Signature”

minOccurs=“0”/>

</sequence>

| | | </complexType> |
|---|---|---|
| Remote | Data type for recording | <complexType name=“RemoteType”> |

| | |
|---|---|
| position of contents | <sequence> |

| | |
|---|---|
| protection tool | <element ref=“dsig:Signature”/> |

| </sequence> | |
|---|---|
| <attribute | name=“ref” |

| | | type=“anyURI”/> |
|---|---|---|
| | | </complexType> |
| ConfigurationSettings | Data type for recording | <complexType |
| | environment parameter | name=“ConfigurationSettingsType” |
| | value of contents | mixed=“true”> |

| | |
|---|---|
| protection tool | <sequence> |

| | |
|---|---|
| <any | namespace=“##any” |

processContents=“lax”
minOccurs=“0”/>

</sequence>

</complexType>

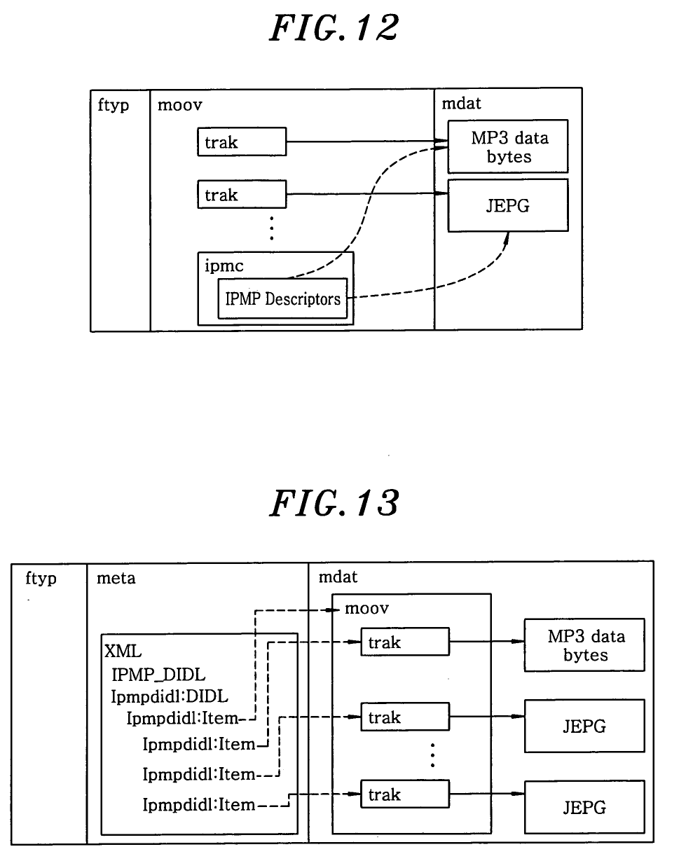

FIG. 12 illustrates an example of a file format structure for protecting single trak box audio and image data by using an MPEG-4 file format in accordance with the present invention. And FIG. 13 describes another example of the file format structure for protecting single trak box audio and image data by using the MPEG-4 file format in accordance with the present invention.

Referring to the example of the file format structure in FIGS. 12 and 13 in accordance with a preferred embodiment of the present invention, content protection information (IPMP Descriptors) on MP3 data and JPEG data may be recorded in an ipmc box in the moov box of the MPEG-4 file format. Alternatively, in another example of the file format structure in accordance with another preferred embodiment of the present invention, protection information (IPMP_DIDL) on the MP3 data and at least one JPEG data may be recorded in an xml box of the MPEG-4 file format. An uppermost item of IPMP (Ipmpdidl:Item) indicates the content protection information for every trak box in the moov box in the mdat box, and lower items thereof (Ipmpdidl:Item) indicate the protection information on the MP3 data and the JPEG data indicated by the corresponding trak boxes in the moov box.

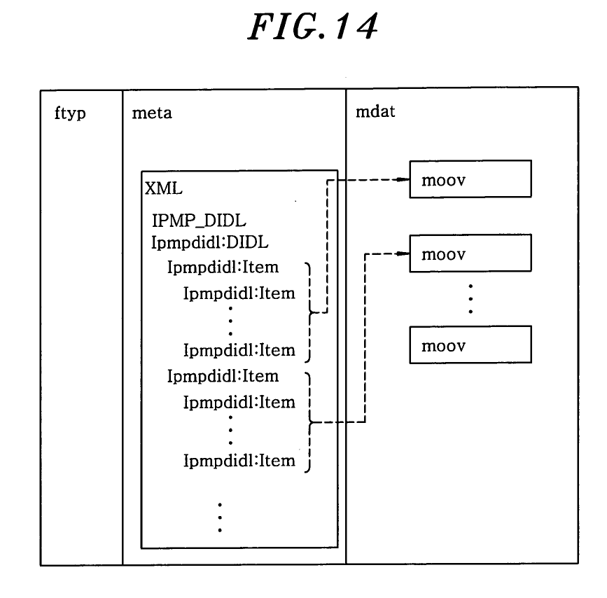

FIG. 14 shows a file format structure which protect multiple trak box audio and image data by using the MPEG-4 file format in accordance with the present invention.

Referring to FIG. 14, the protection information (IPMP_DIDL) on the MP3 data and at least one or more JPEG data in multiple trak boxes may be recorded in the xml box of the MPEG-4 file format. The uppermost items (Ipmpdidl:Item) of the IPMP indicate content protection information contained in the moov boxes in the mdat box. Furthermore, the protection information (IPMP_DIDOL) has an expanded configuration from another type of the file format structure for protecting single trak box audio and image data of FIG. 13.

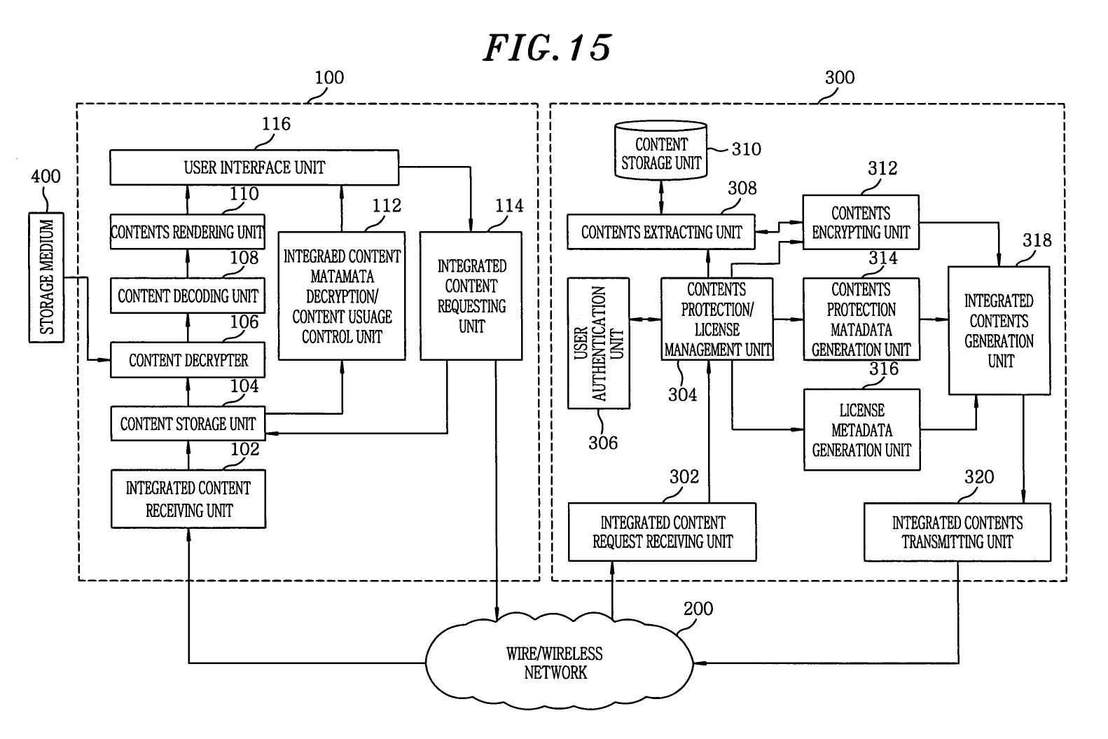

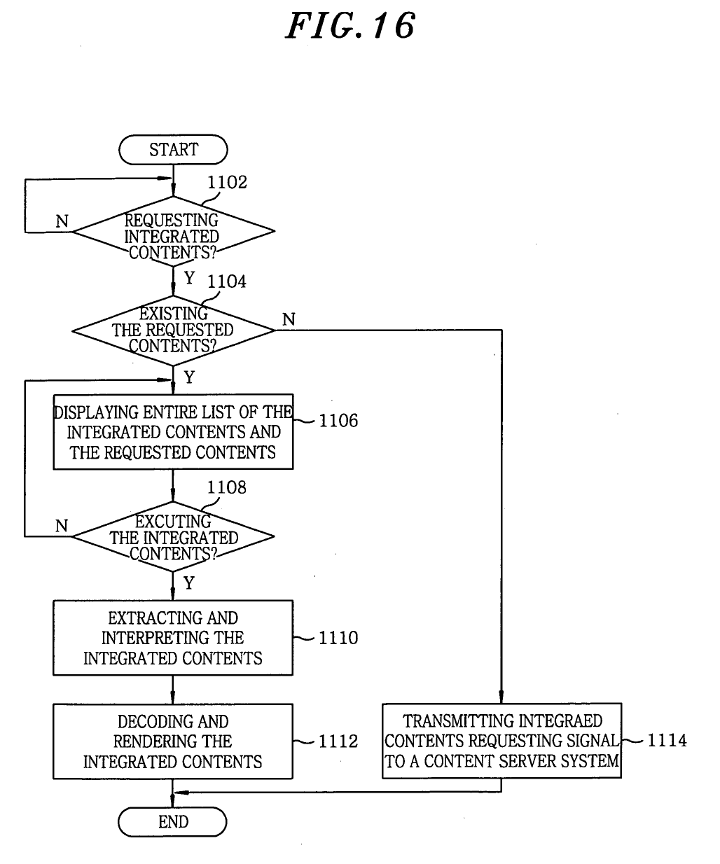

FIG. 15 provides a block diagram of a multimedia service system suitable for providing a multimedia contents service based on an integrated multimedia file format structure in accordance with the present invention. The multimedia service system includes a user information terminal 100, a network 200, a content server system 300 and a storage medium 400.

As shown in FIG. 15, the user terminal 100 includes an integrated content receiving unit 102, a received content storage unit 104, a content decryptor 106, a content decoding unit 108, a contents rendering unit 110, an integrated content metadata decryption/content usage control unit 112, an integrated content requesting unit 114 and a user interface unit 116. The user terminal 100 may include a wire terminal (e.g., a personal computer having a network connection means or the like) or a wireless terminal (e.g., a cellular phone, a PCS, a PDA, an IMT-2000 terminal, a PDA phone, a smart phone and the like). The user terminal 100 allows a user to request integrated contents through the user interface unit 116 with the rights to use the contents.

Furthermore, the user terminal 100 executes the contents request through the integrated content requesting unit 114. If designated integrated contents exist in the content storage unit 104 of the user terminal 100, entire lists of stored integrated contents are displayed on the user terminal 100. Then, in order to display context and sources of the integrated contents as requested in the user interface unit 116, the integrated contents decryption/content usage control unit 112 interprets metadata of the integrated contents and then checks the rights to use the contents before transmitting the decrypted contents to the user interface unit 116.

If integrated contents desired by the user exist in the content storage unit 104 of the user terminal 100, the integrated contents as desired is selected via the integrated content metadata decryption/content usage control unit 112. Then, the integrated contents are extracted according to an execution instruction issued from the user interface unit 116 and then, protected contents are decrypted by the content decryptor 106.

The user's rights for decryption may be stored in the user terminal 100 or in the storage medium 400 and, also, the usage of the contents may be limited according to the user's rights obtained from the content decryptor 106.

The extracted and decrypted contents are respectively decoded by their corresponding contents decoders in the content decoding unit 108 of the user terminal 100 and then rendered through the contents rendering unit 110 followed by the user interface unit 116 to thereby render multiple contents in one screen.

On the other hand, if there exists no the integrated multimedia contents desired by the user in the integrated contents lists displayed at the user interface unit 116 of the user terminal 100, a signal requesting the integrated contents is transmitted from the integrated content requesting unit 114 to the content server system 300 via the network 200, i.e., a wire/wireless communication network.

The content server system 300 includes an integrated content request receiving unit 302, a contents protection/license management unit 304, a user authentication unit 306, a contents extracting unit 308, a content storage unit 310, a contents encrypting unit 312, a contents protection metadata generation unit 314, a license metadata generation unit 316, an integrated contents generation unit 318 and an integrated contents transmitting unit 320. The contents request receiving unit 302 of the content server system 300 receives an integrated contents request signal transmitted via the network 200 and then transmits it to the contents protection/license management unit 304. Furthermore, the user authentication unit 306 of the content server system 300 determines the limit of a user's rights to use contents.

The contents protection/license management unit 304 of the content server system 300 requests the contents extracting unit 308 to extract proper contents from the content storage unit 310 according to the user authentication and the user's rights to use the contents. Then, such provided contents are encrypted by the contents encrypting unit 312 according to a content protection method of the contents protection/license management unit 304.

The contents protection metadata generation unit 314 of the content server system 300 generates contents protection metadata to record information for describing the content protection method of the contents protection/license management unit 304. Also, the license metadata generation unit 316 generates license metadata to record license information in accordance with a decision of the contents protection/license management unit 304.

The integrated contents generation unit 318 of the content server system 300 generates one integrated contents by receiving the encrypted contents, the contents protection metadata, the license metadata, and file format configuration information such as synchronization information of those contents, which are outputted from the contents encoding unit 312, the contents protection metadata generation unit 314 and the license metadata generation unit 316, respectively. The integrated contents thus generated are transmitted to the integrated contents transmitting unit 320 and then, the integrated contents transmitting unit 320 transmits it to the user terminal 100 via the network 200.

In the user terminal 100, the integrated contents are received by the integrated content receiving unit 102 and then stored in the content storage unit 104. Moreover, in order to show that the integrated contents requested by the user have been received, the integrated content metadata decryption/content usage control unit 112 analyzes the received integrated content metadata and then transmits the context of the integrated contents and the rights to use the contents to the user interface unit 116.

Furthermore, in the user terminal 100, the integrated contents requested by the user are extracted according to an execution instruction from the user interface unit 316, and the protected contents are also respectively decrypted by the content decryptor 106 according to the user's rights stored in the user terminal 100 or in the storage medium 400. Such extracted and decrypted contents are decoded by the contents decoders in the content decoding unit 108 and also rendered through the user interface 116 followed by the contents rendering unit 110, thereby rendering multiple contents in one screen.

The storage medium 400 includes, e.g., an optical disk, a hard disk, a memory and the like and is connected with the user terminal 100. Accordingly, random integrated contents (e.g., MP3 data and the like) stored therein are extracted according to the user's request and then transmitted to the content decryptor 106 of the user terminal 100.

The following is a description of a process in which the contents service system configured as described above provides the integrated contents generated based on the integrated multimedia file format structure to the user terminal depending on the user's request and rights.

FIG. 16 is a flow-chart illustrating a process for providing in response to a request for the integrated contents having the integrated multimedia file format structure, contents previously stored in the contents service system in accordance with the present invention provides. And FIG. 17 offers a flowchart showing a process for providing the integrated contents having the integrated multimedia file format structure in response to an integrated contents request signal in the contents service system in accordance with the present invention.

Referring to FIGS. 16 and 17, the user terminal 100 checks whether or not the user has requested random integrated contents through the user interface unit 116 (step 1102).

If it is determined, at the step 1102 that a certain integrated content has been requested, the integrated content requesting unit 114 of the user terminal 100 checks whether or not the requested content exist in the content storage unit 104 (at step 1104).

If it is confirmed at the step 1104 that the requested contents exist, the entire list of the integrated contents including the requested contents stored in the content storage unit 104 is displayed. Next, the integrated content metadata decryption/content usage control unit 112 interprets metadata of the integrated contents and then transmits the decrypted contents to the user interface unit 116 after determining the user's rights. Accordingly, the context and the sources of the requested contents are displayed in the user interface unit 116 (at step 1106).

Thereafter, the user terminal 100 determines whether or not the user has inputted an instruction to render the integrated contents through the integrated content metadata decryption/content usage control unit 112 and the user interface unit 116 (at step 1108).

If it is checked at the step 1108 that the executive instruction for content rendering has been inputted through the user interface unit 116, the integrated contents are extracted from the content storage unit 104 and, then, the protected contents are then decrypted by the content decryptor 106 according to the user's rights stored in the user terminal 100 or the storage medium 400 (at step 1110).

Next, in the user terminal 100, the extracted and decrypted contents are decoded by the contents decoders in the content decoding unit 108, respectively, and then rendered through the user interface unit 116 followed by the contents rendering unit 110 by using the synchronized information recorded in the integrated multimedia file format to thereby render multiple contents in one screen (at step 1112).

Meanwhile, if it is determined at the step 1104 that the requested contents do not exist, the integrated content requesting unit 114 of the user terminal 100 transmits an integrated contents request signal to the content server system 300 via the network 200 (at step 1114).

As shown in FIG. 17, the content server system 300 confirms whether or not the integrated content request receiving unit 302 has received the integrated contents request signal transmitted via the network 200 (step 1202).

If it is determined at the step 1202 that the integrated contents request signal has been received, the contents protection/license management-unit 304 and the user authentication unit 306 perform an user authentication and determine the limit of a user's rights to use contents (at step 1204).

The contents protection/license management unit 304 requests the contents extracting unit 308 to extract the proper contents from the content storage unit 310 according to the user authentication and the user's rights to use the contents. Next, such provided contents are encrypted by the contents encrypting unit 312 according to the contents protecting method from the contents protection/license management unit 304 (at step 1206).

Thereafter, the contents protection metadata generation unit 114 generates contents protection metadata to record information for describing the contents protecting method of the contents protection/license management unit 304, and the license metadata generation unit 316 generates license metadata to record license information in accordance with an instruction issued from the contents protection/license management unit 304 (at step 1208). The integrated contents generation unit 318 produces one integrated contents by receiving the encrypted contents, the contents protection metadata and the license metadata provided from the contents encoding unit 312, the contents protection metadata generation unit 314 and the license metadata generation unit 316, respectively. Such generated integrated contents are transmitted to the integrated contents transmitting unit 320 and then, the integrated contents transmitting unit 320 transmits it therefrom to the user terminal 100 via the network 200 (at step 1210).

Next, in the user terminal 100, the integrated contents are received by the integrated content receiving unit 102 and then stored in the content storage unit 104 (at step 1212). Furthermore, in order to display that the integrated contents requested by the user has been received, the integrated content metadata decryption/content usage control unit 112 interprets the received integrated content metadata and then transmits the context of the integrated contents and the rights to use those contents to the user interface unit 116.

It will be understood that the processes shown in FIGS. 17 and 18 are continuously performed in connection with the aforementioned processes according to the user's request for contents, the existence/nonexistence of the requested contents, the contents request signal transmission/reception and the like.

Accordingly, the multimedia server system can extract contents having an integrated multimedia file format structure from the user terminal according to the user's request or receive contents having an integrated multimedia file format structure from the contents service system connected therewith, the integrated multimedia file format structure being generated by the content server system.

While the invention has been shown and described with respect to the preferred embodiments, it will be understood by those skilled in the art that various changes and modification may be made without departing from the scope of the invention as defined in the following claims.

1. An integrated multimedia file format structure for integrating contents containing at least one among compressed video data, image data, text data and contents information metadata, which correspond to compressed audio data, by using an ISO based file format, the integrated multimedia file format structure comprising:
a moov box for indicating at least one data among the compressed video data, image data, text data, script data for applying animation effects to image, video and text data, the contents protection metadata and license protection metadata, which correspond to compressed audio data, using a multiplicity of trak boxes, and for specifying synchronized text data in an additional trak box;
a mdat box containing the data indicated by the trak boxes of the moov box and the synchronized text data corresponding to the additional trak box; and a meta box for storing metadata where information on the contents is recorded.

2. The integrated multimedia file format structure of claim 1, wherein the meta box contains at least one of the contents protection metadata, the license information metadata, and asynchronous MPEG-7 metadata.

3. The integrated multimedia file format structure of claim 2, wherein the meta box records at least one of the contents protection metadata and the license information metadata and the asynchronous MPEG-7 metadata by using an MPEG-21 DID.

4. The integrated multimedia file format structure of claim 2, wherein the contents protection metadata and the license information metadata indicate content protection information by using an MPEG-21 IPMP (Intellectual Property Management and Protection) components standard.

5. The integrated multimedia file format structure of claim 1, wherein the content protection information on the compressed audio data the image data is recorded in an impc box at the moov box.

6. The integrated multimedia file format structure of claim 1, wherein the protection information (IPMP_DIDL) on the compressed audio data, image data and text data is recorded in an xml box.

7. The integrated multimedia file format structure of claim 1, wherein the script data is configured by using at least one among an MPEG-4 LASeR (Lightweight Application Scene Representation) standard, an SMIL (Synchronized multimedia Integration Language) standard, an SVG (Scalable Vector Graphic) standard, an SVG Tiny standard and an XML standard.

8. The integrated multimedia file format structure of claim 1, wherein the compressed audio data is of at least one file format among file formats of MP2, MPEG-2/4 AAC, WMA, AVI, G.723, PCM, MPEG-4 ALS (Audio Lossless Coding), MPEG-4 DST (Lossless Coding of oversampled audio).

9. The integrated multimedia file format structure of claim 1, wherein the image data is at least one file format among file formats of JPEG, PNG, BMP, TIFF, JPEG2000, MPEG I-frame, GIF, animated GIF, PGMYUV, PGM, YUV, SGI.

10. The integrated multimedia file format structure of claim 9, wherein the image data includes at least one among pictures of a singer(s), pictures of a music album, story-related still images, story-related moving pictures, pictures showing tongue positions for pronunciation of words and images for explaining situations related to dialogues for language learning.

11. The integrated multimedia file format structure of claim 1, wherein the video data supports at least one file format among file formats of H.264/AVC, SVC, MPEG-1, MPEG-2, MPEG-4, WMV, H.261, H.263, H.26L, AVI, RealVideo, DV, MJPEG and Apple Video.

12. The integrated multimedia file format structure of claim 1, wherein the text data includes at least one among song lyrics, story sentences, sentences for language learning and pronunciation of words.

13. The integrated multimedia file format structure of claim 12, wherein the text data includes synchronized text or time information in each segmented text.

14. The integrated multimedia file format structure of claim 13, wherein the synchronized text includes, in a trak box, at least one among a time stamp, an offset and a chunk unit.

15. The integrated multimedia file format structure of claim 13, wherein the synchronized text is an ISO/IEC 14496-17 file format.

16. The integrated multimedia file format structure of claim 1, wherein the contents protection metadata includes encryption tools, encryption keys, encryption position information and encryption parameters for a contents protection.

17. The integrated multimedia file format structure of claim 1, wherein the license information metadata contains at least one among a user authentication key value, a user terminal authentication key value, a content using period contents, a frequency of reproducing the contents and an available period of using the contents.

18. The integrated multimedia file format structure of claim 1, wherein the file format structure is configured by synchronously combining the compressed audio data with at least one of the multiple image data, compressed video data and text data.

19. The integrated multimedia file format structure of claim 1, wherein the compressed audio data in the file format structure has at least one audio track.

20. A multimedia service system for providing integrated contents having an integrated multimedia file format structure, the system comprising:
a content server system for assigning a rights to use the integrated contents, generating license information metadata according to the rights to use the contents, encrypting the contents according to the license information metadata and generating contents protection metadata related to the encryption, thereby generating the integrated contents having the integrated multimedia file format structure and transmitting the same via a network; and
a user terminal for storing the integrated contents received via the network, decrypting and decoding the stored integrated contents according to the license information metadata and the contents protection metadata, displaying the decoded contents and executing the displayed contents according to an instruction for executing the integrated contents.

21. The multimedia service system of claim 20, further comprising a storage medium for providing to the user terminal the integrated contents having the integrated multimedia file format structure.

22. The multimedia service system of claim 20, wherein the content server system includes:
an integrated content request receiving unitintegrated content request receiving unit for receiving an integrated contents request signal transmitted via the network;
a contents protection/license management unit for providing a content protection method of the integrated contents;
a user authentication unit for checking and providing information on a user authentication and a limit of a rights to use contents to the contents protection/license management unit;
a contents extracting unit for requesting proper contents according to the user authentication and the rights to use contents;
a content storage unit for extracting and providing the requested contents;
a contents encrypting unit for encrypting the contents according to the content protection method from the contents protection/license management unit;
a contents protection metadata generation unit for generating contents protection metadata in order to record information for describing the content protection method;
a license metadata generation unit for generating license metadata to record license information in accordance with a decision of the contents protection/license management unit;
an integrated contents generation unit for generating one integrated contents according to synchronized information by using the encrypted contents, the contents protection metadata and the license metadata respectively provided from the contents encrypting unit, the contents protection metadata generation unit and the license metadata generation unit; and
a contents transmitting unit for transmitting the generated integrated contents to the user terminal via the network.

23. The multimedia service system of claim 20, wherein the user terminal includes:
an integrated content receiving unit for receiving the integrated contents transmitted from the content server system;
a content storage unit for storing the received integrated contents and extracting pre-stored integrated contents;
a content decryptor for decrypting the integrated contents according to the user's rights stored in the user terminal or the storage medium;
a content decoding unit for decoding the decrypted integrated contents by using contents decoders;
a contents rendering unit for rendering the decoded integrated contents in one screen;
a contents metadata decryption/content usage control unit for decrypting metadata of the integrated contents and then transmitting the decrypted metadata after determining the rights to use contents;
an integrated content requesting unit for determining whether or not the requested integrated contents exist in the content storage unit and then extracting the requested integrated contents if the requested integrated contents exist in order to provide the same to the integrated content metadata decryption/content usage control unit, or transmitting a contents request signal to the content server system via a wire/wireless communication network if the requested integrated contents are inexistence; and
a user interface unit for displaying entire lists of the previously stored integrated contents and context and sources of the requested integrated contents and providing the rendered integrated contents.

24. A multimedia service method for providing integrated contents having an integrated multimedia file format structure, the method comprising the steps of:
determining whether or not an integrated content request receiving unitintegrated content request receiving unit of a content server system has received a contents request signal transmitted via a network;
performing a user authentication and checking a limit of a user's rights to use contents if the integrated contents request signal is received;
requesting proper contents according to the user authentication and the license and then encrypting the contents as requested according to a content protection method;
generating contents protection metadata for recording information describing the content protection method and license metadata for recording license information of the contents;
generating one integrated contents by using the encrypted contents, the contents protection metadata and the license metadata according to synchronization information and then transmitting the integrated contents to a user terminal via a network; and
storing the integrated contents received from the user terminal.

25. A multimedia service method for providing integrated contents having an integrated multimedia file format structure, the method comprising the steps of:
determining whether or not integrated contents is requested from a user terminal;
determining whether or not the requested contents exist if the integrated contents is requested;
displaying decrypting metadata of the integrated contents after checking a rights to contents and then displaying context and sources of the requested integrated contents if the requested contents exist, entire lists of pre-stored integrated contents;
extracting and decrypting the corresponding contents if an instruction for implementing the random integrated contents is inputted from the user terminal, according to the user's rights stored in the user terminal or a storage medium; and
decoding and rendering the decrypted integrated contents according to the synchronization information and then executing the decoded integrated contents.

26. The multimedia service method of claim 25, further comprising a step transmitting an integrated contents request signal to a content server system via a wire and/or wireless network if the requested contents are inexistence.
